(19) United States
(12) Patent Application Publication
(10) Pub. No.: US 2026/0152899 A1
(43) Pub. Date: Jun. 4, 2026

(54) GLOVE DRYER, SANITIZER, DEODORIZER AND SHAPE MAINTAINER

(71) Applicant: Serialle, Inc., La Mesa, CA (US)

(72) Inventor: Marvin M. Attallah, La Mesa, CA (US)

(73) Assignee: Serialle, Inc., La Mesa, CA (US)

(21) Appl. No.: 18/964,394

(22) Filed: Nov. 30, 2024

(51) Int. Cl. D06F 59/04; F26B 23/10

(52) U.S. Cl. CPC D06F 59/04; F26B 23/10

(57) ABSTRACT

The present application is directed to a Glove Dryer, Sanitizer, Deodorizer and Shape Maintainer embodied by a glove drying apparatus which enables glove drying, glove sanitizing and glove deodorizing while at the same time maintaining the original or a desired shape of the glove being dried. Glove drying device members may be constructed out of solid material or include a hollow member. Solid members may include wood, plastic or a filled textile fabric while the hollow member may be constructed out of wood, metal, plastic or composite materials. Hollow glove drying device inserts will have a plurality of holes therein, and the capability to accept forced air, or a mist of sanitizing and deodorizing compounds. Additionally, the glove drying device may include a glove shape maintaining feature, comprising a width adjustment mechanism. The glove drying apparatus may be used to dry, sanitize and deodorize any fingered glove or mitten.

### FIELD OF THE INVENTION

This application relates to a glove dryer device. More particularly, the present invention embodies a glove drying apparatus which also enables glove sanitizing and glove deodorizing while at the same time maintaining the original or a desired shape of the glove being dried.

### BACKGROUND OF THE INVENTION

Many gloves and mittens become wet when in use. This is especially true for gloves used in casual and recreational use, as well as for work use and used in sports. When gloves and mittens are employed for recreational and sporting purposes, they tend to become wet through both environmental causes, such as water intrusion, and through sweating of the wearer. For example, ski gloves and mittens become wet from both snow melt on the exterior of the glove or mitten and sweat on the interior of the glove or mitten. The same holds true for boxing gloves.

Boxing gloves present additional problems as they accumulate a great deal of sweat which leads to the gloves becoming odorous and misshapen. Odors occur because of the growth of microorganisms. When boxing gloves are left to dry naturally, with no intervention, they are dark damp and dirty inside, which is a recipe for microbe growth. Many microbes that thrive in these conditions produce foul odors and can ruin good boxing gloves very quickly if those gloves are not treated. Therefore, to properly treat boxing gloves after use, they should be dried, sanitized and deodorized.

Not only does proper treatment of boxing gloves include drying, but it also includes maintaining proper shape. When a boxing glove becomes misshapen inside, it takes on an unusual or wrong shape, and as a result it does not fit or function properly on the boxer's hand. Many boxers deal with this in various ways. Some glove owners stuff newspapers inside the glove after use to assist in drying and maintaining proper glove shape. This technique assists somewhat with drying and shape maintaining, but it does nothing to address the need to sanitize or deodorize the glove. Proper care extends the life of often used gloves and mittens.

Not only does proper treatment of boxing gloves include drying, but it also includes cleaning dirty used boxing gloves. Some glove owners wash their boxing gloves in a conventional clothes washer. This presents an additional problem of ending up with a very wet glove and the drying process become very lengthy. Because boxing gloves are made from leather and leather like materials, they cannot be dried in a conventional clothes dryer. This would quickly destroy the boxing gloves. Moreover, some glove owners have resorted to soaking their used stinky gloves in salt water. Again, this presents the problem of how you dry the soaked glove. Air drying would take days. There currently exists no easy solution.

Not only does proper treatment of boxing gloves include drying, but it also includes sanitizing dirty used boxing gloves. This is especially true at gyms, where multiple users may use the same gloves over and over. Some gym and glove owners have used sanitizing sprays. This technique makes the used sweaty gloves increasingly wet with moisture, and again, drying times become long.

Not only does proper treatment of boxing gloves include drying, but it also includes deodorizing dirty used boxing gloves. Used boxing gloves quickly smell awful with continued use. Left untreated, this awful smell can ruin a pair of good gloves quickly, forcing the glove owner to throw the gloves away. Some glove owners have used deodorizing packets and deodorizing sprays. The deodorizing spray technique makes the used sweaty gloves even wetter, and again, drying times become very long. Using deodorizing packets, usually filled with baking soda or some other odor capturing compound also take quite a bit of time to deodorize boxing gloves, making them unavailable for use during the lengthy deodorization process.

Therefore, there presently exists a long felt need for a device which is capable of drying casual and recreational gloves and mittens, as well as work and sporting gloves, such as boxing gloves, and at the same time sanitizing and deodorizing the glove, while also maintaining the important boxing or sporting glove shape, essentially preserving the gloves functioning over time and making them quickly available for use soon after a boxing or other sporting session. Moreover, properly caring for gloves and mitten extends the useful life of the gloves or mittens.

In this respect, before explaining at least one embodiment of the Glove Dryer, Sanitizer, Deodorizer and Shape Maintainer in greater detail, it is to be understood that the design is not limited in its application to the details of construction and to the arrangement of the components set forth in the following description or illustrated in the drawings. The Glove Dryer, Sanitizer, Deodorizer and Shape Maintainer is capable of other embodiments and of being practiced and carried out in various ways. Also, it is to be understood that the phraseology and terminology employed herein are for the purpose of description and should not be regarded as limiting.

### SUMMARY OF THE INVENTION

The preferred embodiment of the Glove Dryer, Sanitizer, Deodorizer and Shape Maintainer will have the capability to passively and actively dry gloves while at the same time sanitizing, deodorizing and maintaining the shape of the gloves being dried.

The primary advantage of the Glove Dryer, Sanitizer, Deodorizer and Shape Maintainer is that it is capable of passively and actively dry gloves while at the same time sanitizing, deodorizing and maintaining the shape of the gloves being dried.

Another advantage of the Glove Dryer, Sanitizer, Deodorizer and Shape Maintainer is that it can be configured in a solid form having an adjustable hand and thumb width for drying while at the same time maintaining the shape of the glove being dried.

Yet another advantage of the Glove Dryer, Sanitizer, Deodorizer and Shape Maintainer is that it can be configured in a hollow form having an adjustable hand and thumb width for drying while at the same time maintaining the shape of the glove being dried.

A further advantage of the Glove Dryer, Sanitizer, Deodorizer and Shape Maintainer is that it can be configured with electronically powered fans and temperature as well as timer displays.

Another advantage of the Glove Dryer, Sanitizer, Deodorizer and Shape Maintainer is that it can be configured to include rack hanging members in order to be mounted on a wall rack for drying.

Yet another advantage of the Glove Dryer, Sanitizer, Deodorizer and Shape Maintainer is that it can be structured to dry gloves with fingers and thumb portions as well as mittens with thumb portions.

A further advantage of the Glove Dryer, Sanitizer, Deodorizer and Shape Maintainer is that it can be configured to accept forced air into the device to speed up the drying process.

Another advantage of the Glove Dryer, Sanitizer, Deodorizer and Shape Maintainer is that it can be structured to include an adjustable width in order to maintain the proper glove shape during the drying process.

Another advantage of the Glove Dryer, Sanitizer, Deodorizer and Shape Maintainer it can be configured into a hollow perforated structure shaped specifically to maintain the shape of the glove being dried.

Another advantage of the Glove Dryer, Sanitizer, Deodorizer and Shape Maintainer it can include internal heating elements in order to provide heat to expedite the drying process.

Another advantage of the Glove Dryer, Sanitizer, Deodorizer and Shape Maintainer it can be configured with air accepting holes for the purpose of accepting air supply lines.

Another advantage of the Glove Dryer, Sanitizer, Deodorizer and Shape Maintainer it can be mounted on a wall drying system having a plurality of air supply tubes, wherein said numerous air supply tubes are used to both provide forced air into the gloves but also used to mount the gloves for drying on the wall drying system.

A further advantage of the Glove Dryer, Sanitizer, Deodorizer and Shape Maintainer is that it can be configured to accept forced air and a sanitizing and deodorizing mist into the glove drying device to both speed up the drying process, and to allow for the sanitizing and deodorizing of a variety of casual and recreational gloves and mittens, work gloves and sports gloves, such as boxing gloves, when being dried.

These together with other advantages of the Glove Dryer, Sanitizer, Deodorizer and Shape Maintainer, along with the various features of novelty, which characterize the design are pointed out with particularity in the claims annexed to and forming a part of this disclosure. For a better understanding of the Glove Dryer, Sanitizer, Deodorizer and Shape Maintainer its operating advantages and the specific objects attained by its uses, reference should be made to the accompanying drawings and descriptive matter in which there are illustrated the preferred and alternate embodiments of the Glove Dryer, Sanitizer, Deodorizer and Shape Maintainer. There has thus been outlined, rather broadly, the more important features of the design in order that the detailed description thereof that follows may be better understood, and in order that the present contribution to the art may be better appreciated. There are additional features of the Glove Dryer, Sanitizer, Deodorizer and Shape Maintainer that will be described hereinafter, and which will form the subject matter of the claims appended hereto.

The preferred embodiment of the Glove Dryer, Sanitizer, Deodorizer and Shape Maintainer embodies a glove drying apparatus which also enables glove drying, glove sanitizing and glove deodorizing while at the same time maintaining the original or desired shape of the glove being dried. The glove drying device members may be constructed out of solid material or include a hollow member. The solid members may include wood, plastic or a filled textile fabric while the hollow member may be constructed out of wood, metal, plastic or composite materials. The hollow glove drying device inserts will have the capability to accept forced air, or a mist of sanitizing and deodorizing compounds. Additionally, the glove drying device may include a glove shape maintaining feature, comprising a width adjustment mechanism.

In alternate embodiments of the Glove Dryer, Sanitizer, Deodorizer and Shape Maintainer the taught and claimed glove drying devices may be electrically powered and accept forced air from fans, or accept forced air from outside air supply lines. The glove drying apparatus inserts may also include heating elements for rapid drying processes. In some instances, the glove drying apparatus may be in a pedestal stand configuration rather than a glove insert device. The glove insert devices disclosed and described herein may accommodate hanging on a glove drying wall rack system, and in some embodiments, these wall drying rack systems may supply electricity, forced air, or forced mist onto the gloves for the purpose of sanitizing, deodorizing and drying the gloves while at the same time maintaining the shape of the gloves being dried.

Glove Dryer, Sanitizer, Deodorizer and Shape Maintainer primary features will include as prominent design and operational features: hollow or solid glove drying members having the ability to dry gloves efficiently; hollow or solid glove drying members having the ability to dry gloves efficiently including internal glove hand and thumb width adjustment mechanisms structured to maintain the shape of the glove during the drying process; optionally including a system to introduce forced air into the hollow glove drying members; optionally including glove drying inserts having electrically powered fans to introduce forced air into the hollow glove drying members; having glove drying inserts which enable wall rack mounting; having the wall rack systems capable of providing electrical power and forced air through air supply lines; wall rack systems capable of providing a mist of sanitizing compounds, and deodorizing compounds or both; glove drying members having heating elements therein for expedited glove drying; single or double pedestal glove drying devices capable of accepting forced air, pulsed air and a mist of sanitizing compounds, and deodorizing compounds or both.

With respect to the above description then, it is to be realized that the optimum dimensional relationships for the parts of the Glove Dryer, Sanitizer, Deodorizer and Shape Maintainer, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present design. Therefore, the foregoing should be considered as illustrative only of the principles of the Glove Dryer, Sanitizer, Deodorizer and Shape Maintainer. Further, since numerous modifications and changes will readily occur to those skilled in the art, it is not desired to limit the Glove Dryer, Sanitizer, Deodorizer and Shape Maintainer to the exact construction and operation shown and described, and accordingly, all suitable modifications and equivalents may be resorted to falling within the scope of this application.

### BRIEF DESCRIPTION OF THE DRAWINGS

The accompanying drawings, which are incorporated in and form a part of this specification, illustrate embodiments, which are obvious variants of the Glove Dryer, Sanitizer, Deodorizer and Shape Maintainer and together with the description, serve to explain the principles of this application.

FIG. 1 depicts a front view of a typical boxing glove for reference;

FIG. 2 depicts a thumb side view of a typical boxing glove for reference;

FIG. 3 depicts a hand side view of a typical boxing glove for reference;

FIG. 4 depicts a front view of a width adjustable solid glove dryer inserted into a boxing glove;

FIG. 5 depicts a side view of a width adjustable solid glove dryer inserted into a boxing glove;

FIG. 6 depicts a rear view of an alternate embodiment of a threaded width adjustable solid glove dryer inserted into a boxing glove;

FIG. 7 depicts a front view of an alternate embodiment of a threaded width adjustable solid glove dryer inserted into a boxing glove;

FIG. 8 depicts a front perspective view of an alternate embodiment of an electrically powered hollow glove dryer;

FIG. 9 depicts a front view of another alternate embodiment of an electrically powered hollow glove dryer;

FIG. 10 depicts a thumb side view of the alternate embodiment of an electrically powered hollow glove dryer in FIG. 8 and FIG. 9 mounted on a rack system attached to a wall;

FIG. 11 depicts an alternate embodiment of a adjustable hollow glove dryer capable of drying both mitten type gloves and fingered gloves;

FIG. 12 depicts an alternate embodiment of an adjustable hollow glove dryer capable of drying both mitten type gloves and fingered gloves;

FIG. 13 depicts an alternate embodiment of a width adjustable cloth glove dryer filled with deodorizing compound;

FIG. 14 depicts an alternate embodiment of a width adjustable cloth glove dryer filled with deodorizing compound;

FIG. 15 depicts a hollow perforated glove insert which directs air flow through to the interior of a glove to dry the glove;

FIG. 16 depicts a hollow perforated glove insert which directs air flow through to the interior of a glove to dry the glove;

FIG. 17 depicts a hollow perforated glove insert which directs air flow through to the interior of a glove to dry the glove, shown inserted into a boxing glove;

FIG. 18 depicts a flexible tube glove dryer device having multiple heating elements attached thereto;

FIG. 19 depicts a cutaway close up detailed view of one of the heating elements shown in FIG. 18;

FIG. 20 depicts a front perspective view of a solid glove dryer insert having holes for accepting air flow fans or air flow pipes;

FIG. 21 depicts a front perspective view of a hollow glove dryer insert having a plurality of holes capable of circulating air, equipped with a dual fan electrically powered air flow system;

FIG. 22 depicts a breakaway view of the solid glove dryer insert having holes for accepting air pipes, equipped with a dual fan electrically powered air flow system shown in FIG. 21;

FIG. 23 depicts a dual fan electrically powered air flow system mountable on the solid or hollow glove dryer insert having holes for accepting air flow fans as shown in FIG. 21 or air flow pipes as shown in FIG. 20 and FIG. 22;

FIG. 24 depicts a hollow glove dryer insert having a plurality of holes capable of circulating air, equipped with a dual fan electrically powered air flow system inserted into a boxing glove;

FIG. 25 depicts a solid glove dryer insert having holes for accepting air pipes inserted into a boxing glove;

FIG. 26 depicts a wall rack system having air flow pipes capable of mounting a glove thereon for drying;

FIG. 27 depicts a front perspective view of a hollow glove dryer insert having a plurality of holes capable of circulating air and two air flow holes having tubes inserted therein;

FIG. 28 depicts a multiple glove drying and sanitizing and deodorizing system in a wall rack for mounting gloves thereon;

FIG. 29 depicts a hand side view of a single glove pedestal dryer device, having a boxing glove thereon, capable of pulsating air in and out of the hollow center stand mount;

FIG. 30 depicts a front view of a single glove pedestal dryer device, having a boxing glove thereon, capable of pulsating air in and out of the hollow center stand mount, shown having air coming in;

FIG. 31 depicts a hand side view of a single glove pedestal dryer device, having a mitten thereon, capable of pulsating air in and out of the hollow center stand mount, shown having air coming out;

FIG. 32 depicts a front view of a single glove pedestal dryer device, having a mitten thereon, capable of pulsating air in and out of the hollow center stand mount, shown having air coming in and out simultaneously;

FIG. 33 depicts a side view of a single glove pedestal dryer device, having a glove thereon, capable of pulsating air in and out of the hollow center stand mount, shown having air coming in;

FIG. 34 depicts a side view of a single glove pedestal dryer device, having a glove thereon, capable of pulsating air in and out of the hollow center stand mount, shown having air coming out;

FIG. 35 depicts a front view of a double glove pedestal dryer device capable of pulsating air in and out of the hollow center stand mounts; and

FIG. 36 depicts a single glove pedestal dryer device capable of pulsating a sanitizing and deodorizing mist coming from a liquid reservoir and a misting mechanism, all obvious variants and all constructed in accordance with the present invention as disclosed and described within this specification and the accompanying drawing figures.

### DETAILED DESCRIPTION OF THE PREFERRED EMBODIMENTS

As required, the detailed embodiments of the present Glove Dryer, Sanitizer, Deodorizer and Shape Maintainer 120, 140, 180, 220, 250, 280, 300, 320, 340, 360, 380, 400, 420, 450, 500, 540 and 580, which are all obvious variants, are disclosed herein, however, it is to be understood that the disclosed embodiments are merely exemplary of the design that may be embodied in various forms. Therefore, specific functional and structural details disclosed herein are not to be interpreted as limiting, but merely as basic for the claims and as a representative basis for teaching one skilled in the art to variously employ the present design in virtually any appropriately detailed structure as well as combination.

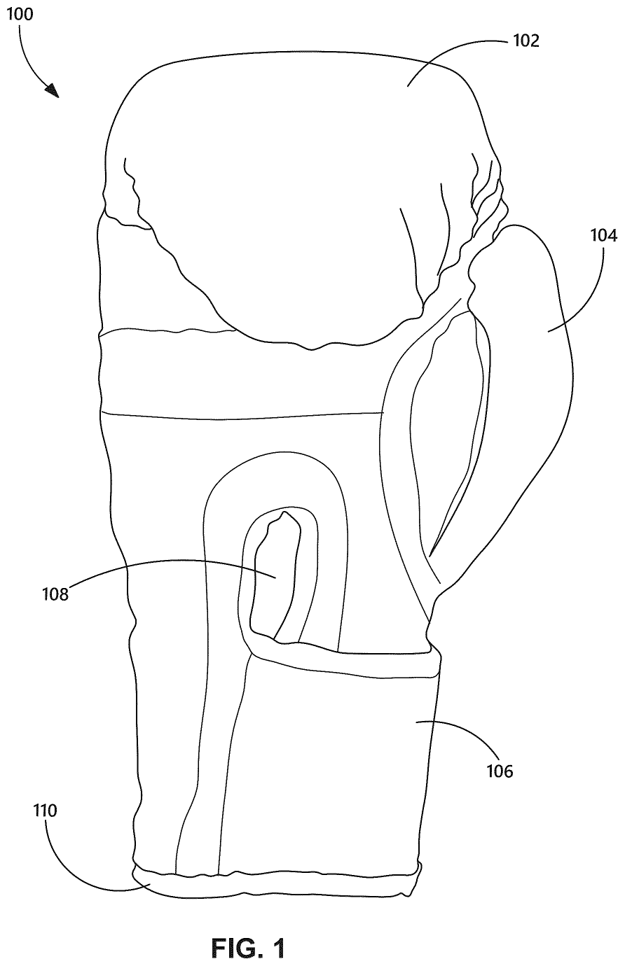

FIG. 1 depicts a front view of a typical boxing glove 100 for reference, especially for describing the various parts thereof throughout this specification. A typical boxing glove 100 has a hand section 102, a thumb section 104, a cuff section 106 which when closed forms an opening 108 and a cuff ending rim section 110.

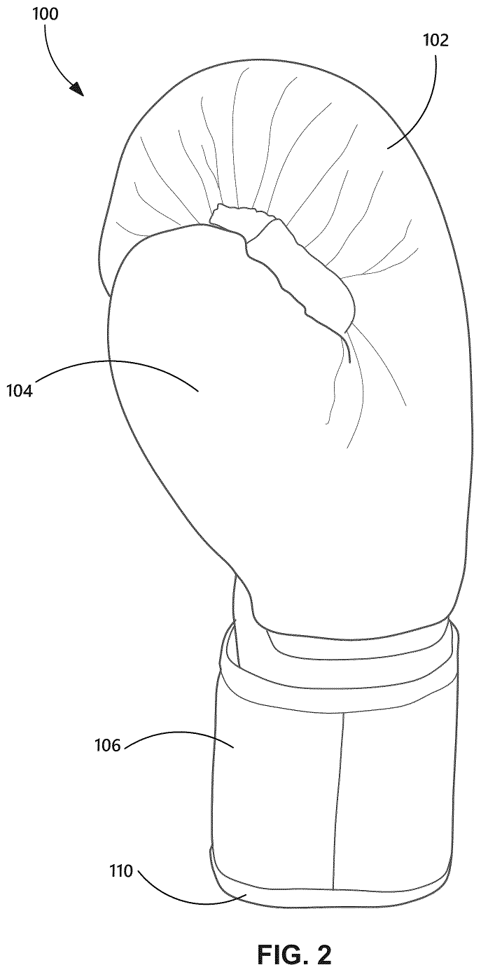

FIG. 2 depicts a thumb side view of the boxing glove 100 as shown in FIG. 1 for reference of the various parts, including a hand section 102, a thumb section 104, a cuff section 106 which when closed forms an opening 108 (not seen in this view) and a cuff ending rim section 110.

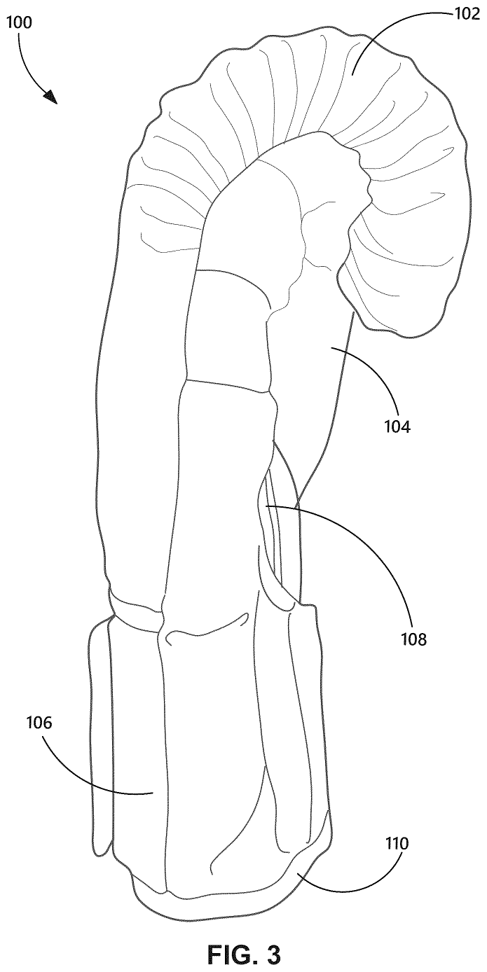

FIG. 3 depicts a hand side view of the boxing glove 100 as shown in FIG. 1 for reference of the various parts, including a hand section 102, a thumb section 104, a cuff section 106 which when closed forms an opening 108 and a cuff ending rim section 110.

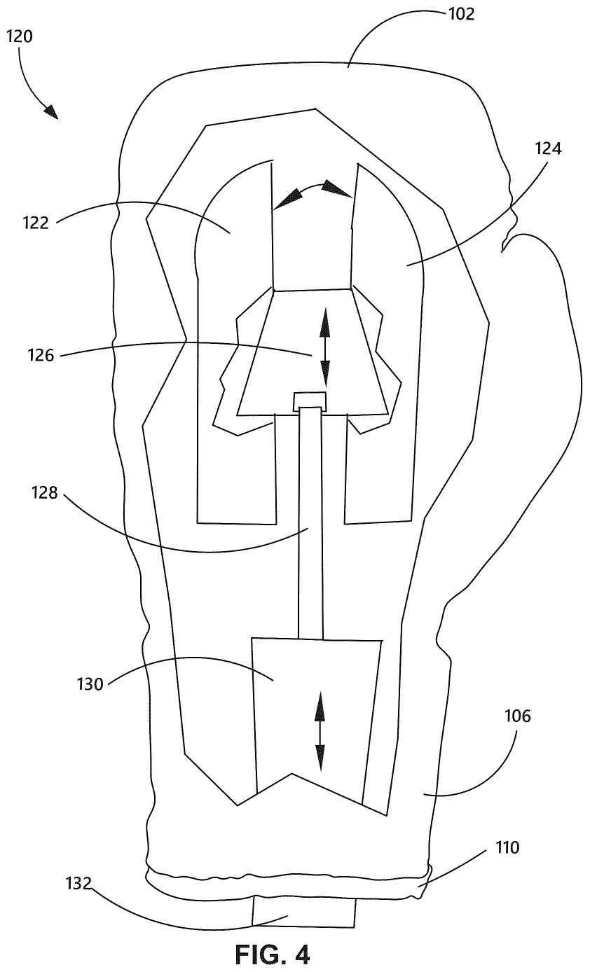

FIG. 4 depicts a cutaway front view of a boxing glove 102 having a width adjustable solid glove dryer device 120 inserted into said boxing glove 102. This width adjustable solid glove dryer device 120 includes a right side portion 122, a left side portion 124 both actuated by a moving wedge 126 which is connected to an adjustment shaft 128 extending down to a cuff portion 130 which bottom portion 132 protrudes out of the cuff end rim section 110. This width adjustable solid glove dryer device 120 is manually operated to perform width adjustments by moving the cuff portion 130 upwardly and downwardly to force the moving wedge to spread out, or contract in the right side portion 122, a left side portion 124 (see direction arrows).

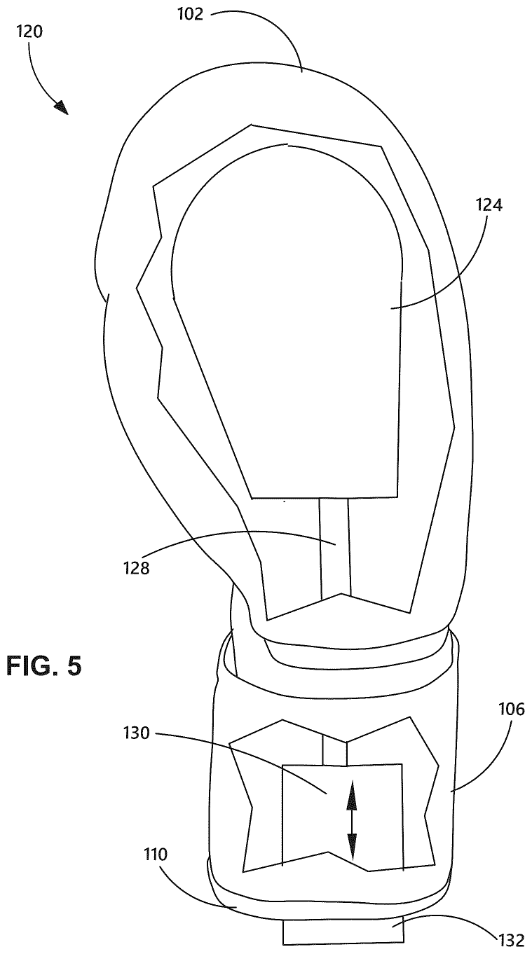

FIG. 5 depicts a side view of a width adjustable solid glove dryer 120 inserted into a boxing glove showing the width adjustable solid glove dryer device 120 left side portion inserted into the boxing glove hand section 102. Also seen here in FIG. 5 is the adjustment shaft 128 extending down to a cuff portion 130 which bottom portion 132 protrudes out of the cuff end rim section 110. Again, the width adjustable solid glove dryer device 120 is manually operated to perform width adjustments within the boxing glove by moving the cuff portion 130 upwardly and downwardly to force the moving wedge 126 (not seen) to spread out, or contract in the right side portion 122 (not seen) and left side portion 124 (see direction arrows). This width adjustable solid glove dryer 120 may be constructed of any solid moisture absorbing material, such as wood. In this way, the width adjustable solid glove dryer 120 is able to maintain the shape of the glove being dried during the drying process.

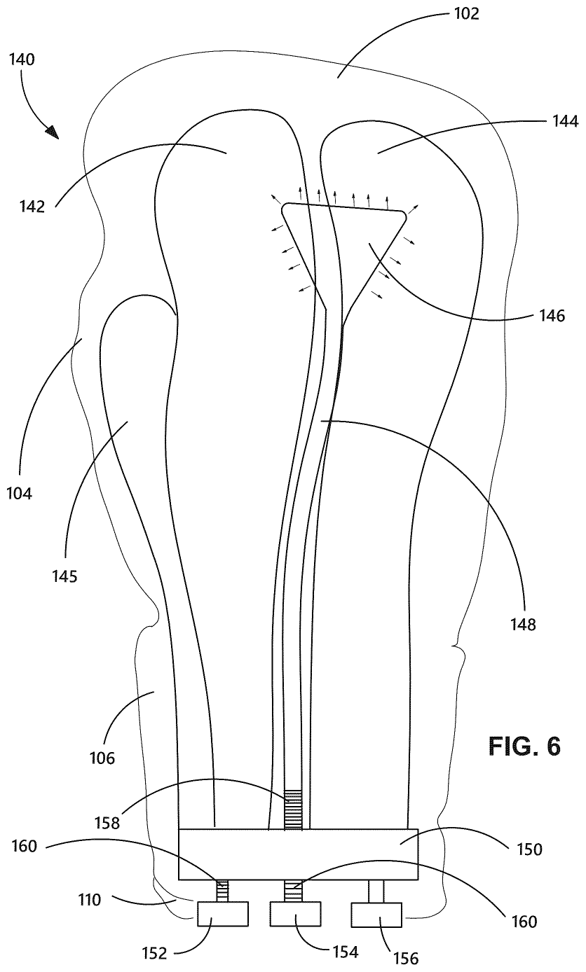

FIG. 6 depicts a rear view of an alternate embodiment of a threaded width adjustable solid glove dryer 140 inserted into the hand section 102 of a boxing glove. This threaded width adjustable solid glove dryer 140 includes a left section 142, a right section 144 and a moving wedge 146 on a shaft 148 having an upper threaded end 158 and a lower threaded end 160 secured to a cuff end portion knob housing 150. The cuff end portion has three rotatable adjustment knobs 152, 154 and 156 attached thereto through internal threads (not seen). When rotatable adjustment knob 154 is turned it enables the shaft 148 to be moved upwardly and downwardly, thereby moving the moving wedge up to contract the two sections 142 and 144 or down to spread the two sections 142 and 144. In this way, the interior shape of the boxing glove is maintained while the glove is drying.

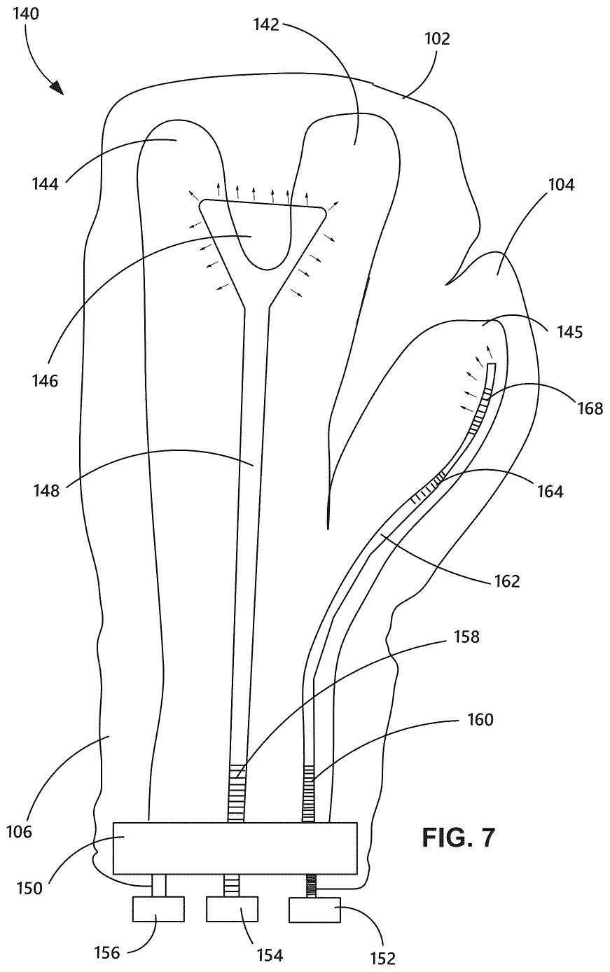

FIG. 7 depicts a front view of an alternate embodiment of a threaded width adjustable solid glove dryer 140 inserted into the hand section 102 of a boxing glove. This threaded width adjustable solid glove dryer 140 includes a left section 142, a right section 144 and a moving wedge 146 on a shaft 148 having an upper threaded end 158 and a lower threaded end 160 secured to a cuff end portion knob housing 150. The cuff end portion has three rotatable adjustment knobs 152, 154 and 156 attached thereto through internal threads (not seen). When rotatable adjustment knob 154 is turned it enables the shaft 148 to be moved upwardly and downwardly, thereby moving the moving wedge up to contract the two sections 142 and 144 or down to spread the two sections 142 and 144. In addition to the hand section 102 width adjustment mechanism, the glove dryer 140 also includes a thumb shape adjustment portion 145. This thumb shape adjustment portion 145 includes a shaft 162 having a threaded portion 160 secured to the cuff end portion knob housing 150 and ending in an adjustment knob 152. Moreover, within the thumb portion 104 the shaft 162 includes flexible sections 164 and 168 which can be adjusted before inserting the threaded width adjustable solid glove dryer 140 into the glove. Rotating the adjustment knob 152 causes the shaft 162 threads 160 to move up or down, thereby adjusting the inner width of the thumb portion 145 (see direction arrows). In this way, the interior shape of the boxing glove is maintained while the glove is drying.

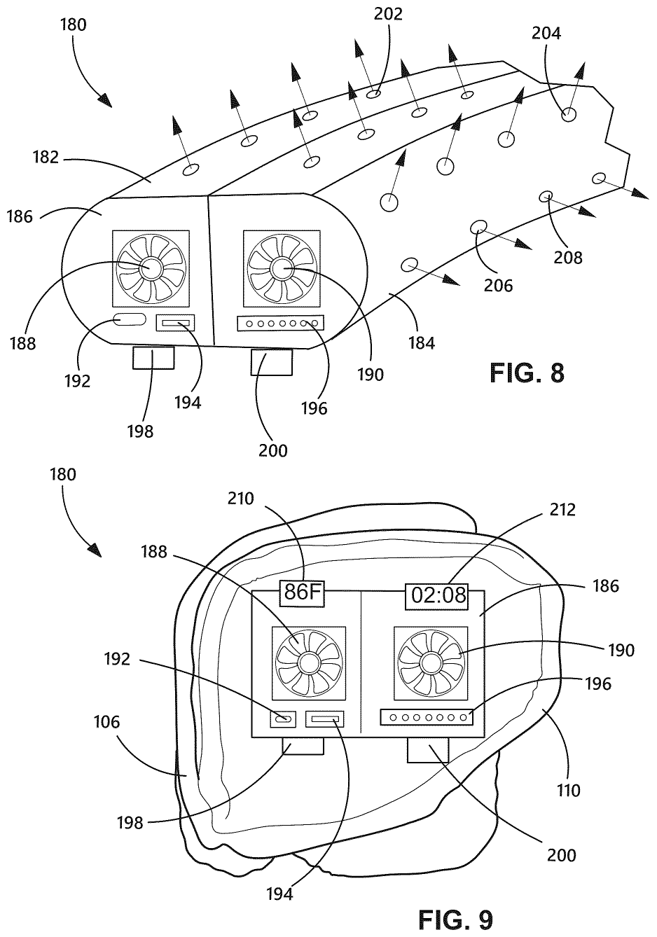

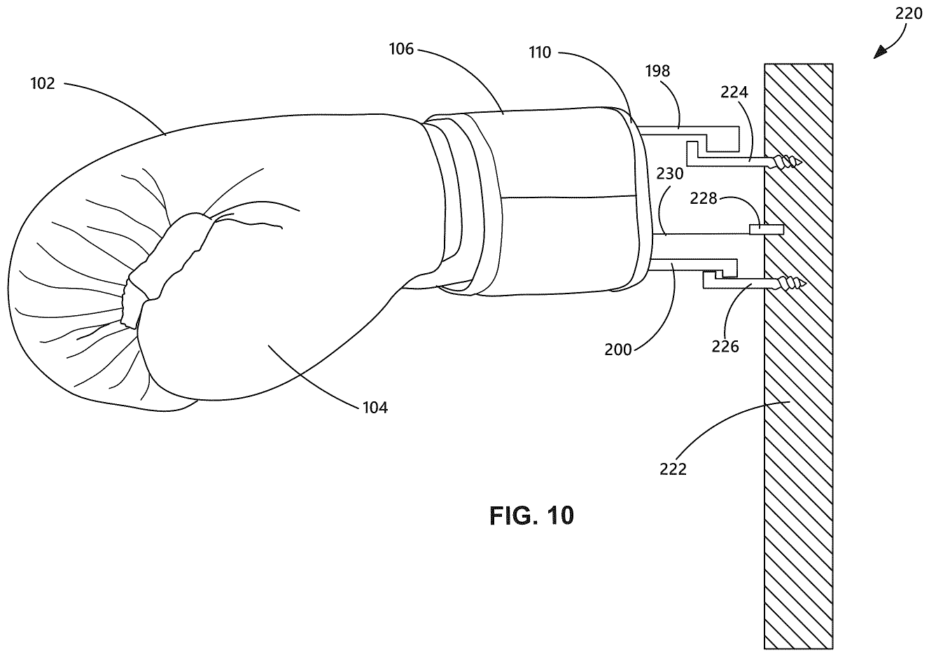

FIG. 8 depicts a front perspective view of an alternate embodiment of an electrically powered hollow glove dryer 180. This electrically powered hollow glove dryer 180 includes two half sections 182 and 184 having an end plate housing 186 capable of housing two fans 188 and 190. The two half sections 182 and 184 include a plurality of holes 202, 204, 206 and 208 to allow for air flow into the glove from the fans 188 and 190 for glove drying. The fans 188 and 190 are electrically powered through either a USB-C port 192 or a USB-A port 194. The timer 196 can be set for any number of setting for timing the running fans for glove drying. Additionally, this electrically powered hollow glove dryer 180 includes two rack pullouts 198 and 200 for use with a wall rack system as described below in FIG. 10.

FIG. 9 depicts a front view of another alternate embodiment of an electrically powered hollow glove dryer 180. Here the two half sections 182 and 184 also have an end plate housing 186 capable of housing two fans 188 and 190 and further include a digital temperature readout display 210 and digital timer readout display 212.

FIG. 10 depicts a thumb side view of the alternate embodiment of an electrically powered hollow glove dryer in FIG. 8 and FIG. 9 mounted on a rack system 220 attached to a wall 222. The wall system includes two rack pegs 224 and 226 screwed into the wall 222. These two rack pegs 224 and 226 mate with the slide out rack pullouts 198 and 200 attached to the drying unit 180 (see FIG. 8 and FIG. 9). Additionally, a USB port 228 is located next to every glove mount to enable power to the fans in electrically powered hollow glove dryer 180 by plugging in the power wire 230 into USB-C port 192 or the USB-A port 194 on the electrically powered hollow glove dryer 180. It is anticipated that the wall rack system 220 could hold any number of pairs of gloves for drying purposes.

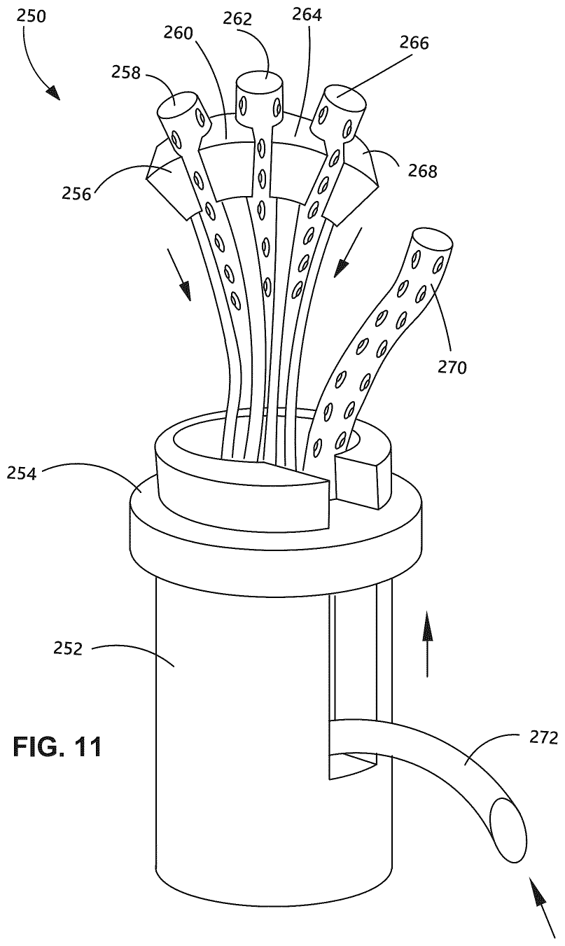

FIG. 11 depicts an alternate embodiment of an adjustable hollow glove dryer 250 capable of drying both mitten type gloves and fingered gloves as well. This adjustable hollow glove dryer 250 includes a hollow standing base 252, a movable standing base collar 254, and a number of finger dryer spacers 256, 260, 264 and 268 used to spread out or bring together the hollow finger drying members 258, 262, and 266. The hollow finger drying members 258, 262, and 266 are adjusted for varying glove sizes by moving the finger dryer spacers 256, 260, 264 and 268 up and down (see direction arrows). Moreover, the standing base collar 254 can be adjusted upwardly or downwardly depending on the overall size of the glove to be dried (see direction arrows). Additionally, the adjustable hollow glove dryer 250 with a hollow standing base 252 includes a thumb drying member 270. Air flows into the standing base 252 from an air source (not shown) through an air feed tube 272 (see direction arrow). In order to dry the glove, that air flows into the individual hollow finger drying members 258, 262, and 266 and out through the plurality of holes within those hollow finger drying members 258, 262, and 266 to dry the glove. Not only is this adjustable hollow glove dryer 250 capable of drying both mitten type gloves and fingered gloves it also functions to maintain the shape of both by being adjustable to the size of the glove and the finger length of the glove being dried therein. In this FIG. 11 view, the adjustable hollow glove dryer 250 is shown in the furthest upward position for drying a small sized glove.

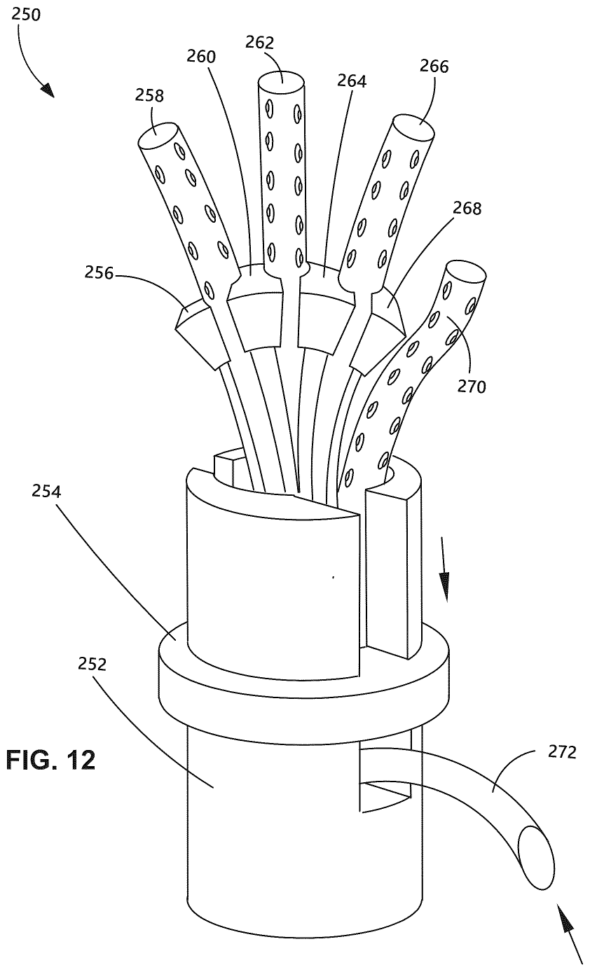

FIG. 12 depicts another view of the alternate embodiment of an adjustable hollow glove dryer 250 as shown in FIG. 11. The adjustable hollow glove dryer 250 is capable of drying both mitten type gloves and fingered gloves. Moreover, the adjustable hollow glove dryer 250 is capable of accommodating varying sizes of gloves having varying finger lengths. In this FIG. 12 view, the adjustable hollow glove dryer 250 is shown in the furthest downward position for drying a large sized glove.

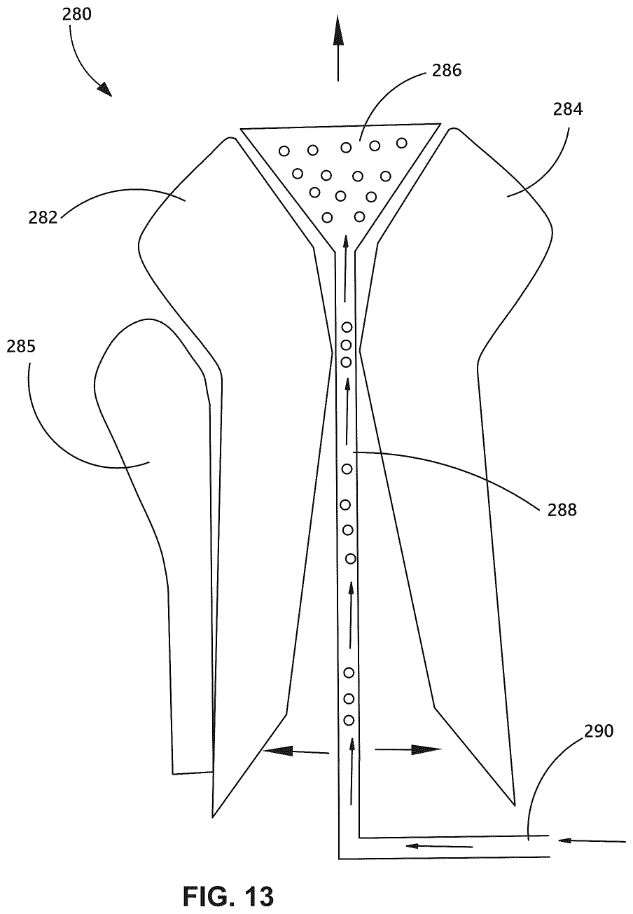

FIG. 13 depicts an alternate embodiment of a width adjustable cloth glove dryer 280 filled with deodorizing compound. This width adjustable cloth glove dryer 280 can be constructed of any air permeable material such as cloth, and be filled with any odor capturing compound, such as baking soda or rice. The width adjustable cloth glove dryer 280 includes a left side portion 282, a right side portion 284 and a thumb portion 285. The left side portion 282 and right side portion 284 are split and positioned adjacent to a hollow moving wedge 286 located at the top of a hollow air feed tube 288 being fed air from an air line 290. The hollow moving wedge 286 and the hollow air feed tube 288 both include a plurality of holes therein. In operation, the moving wedge 286 is actuated upwardly or downwardly to by moving the hollow air feed tube up and down, in order to adjust the width for any particular glove to be dried therein. When the hollow moving wedge is in the up position (as shown here in FIG. 13) then the left side portion 282 and right side portion 284 are split by the closest distance to accommodate a smaller glove size (see direction arrows). For drying, air is sent from the air line 290 into the hollow air feed tube 288 then through the plurality of holes in both the hollow moving wedge 286 and the hollow air feed tube 288. In this way, the glove is dried while simultaneously maintaining the interior glove shape in its optimal form. Here in FIG. 13, the hollow moving wedge 286 is in the upward position to accommodate a smaller glove size.

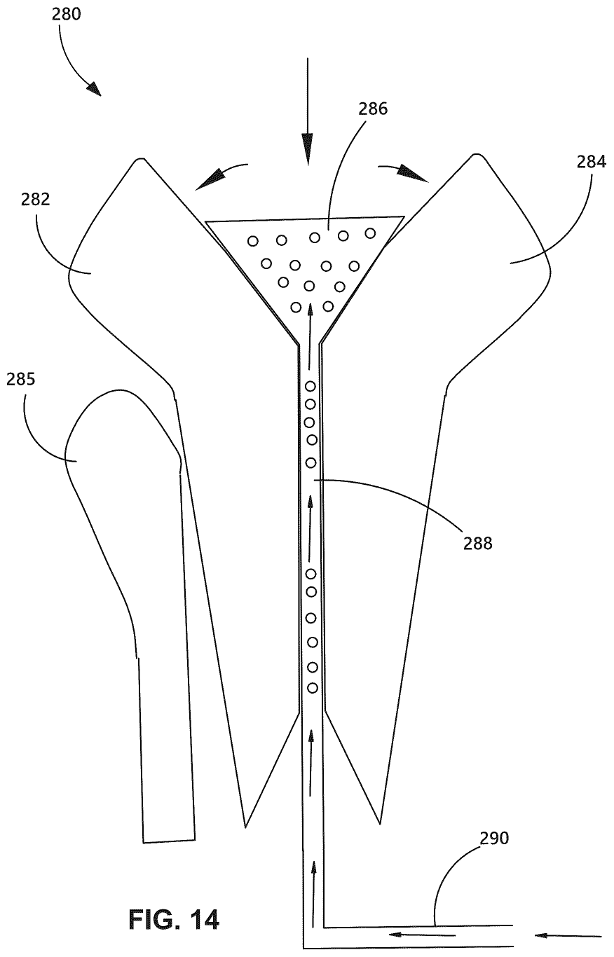

FIG. 14 depicts an alternate embodiment of a width adjustable cloth glove dryer 280 filled with deodorizing compound. The width adjustable cloth glove dryer 280 includes a left side portion 282, a right side portion 284 and a thumb portion 285. The left side portion 282 and right side portion 284 are split and positioned adjacent to a hollow moving wedge 286 located at the top of a hollow air feed tube 288 being fed air from an air line 290. The hollow moving wedge 286 and the hollow air feed tube 288 both include a plurality of holes therein. In operation, the moving wedge 286 is actuated upwardly or downwardly to by moving the hollow air feed tube up and down, in order to adjust the width for any particular glove to be dried therein. When the hollow moving wedge is in the down position (as shown here in FIG. 14) then the left side portion 282 and right side portion 284 are split by the farthest distance to accommodate a larger glove size (see direction arrows). For drying, air is sent from the air line 290 into the hollow air feed tube 288 then through the plurality of holes in both the hollow moving wedge 286 and the hollow air feed tube 288. In this way, the glove is dried while simultaneously maintaining the interior glove shape in its optimal form. Here in FIG. 14, the hollow moving wedge 286 is in the downward position to accommodate a larger glove size.

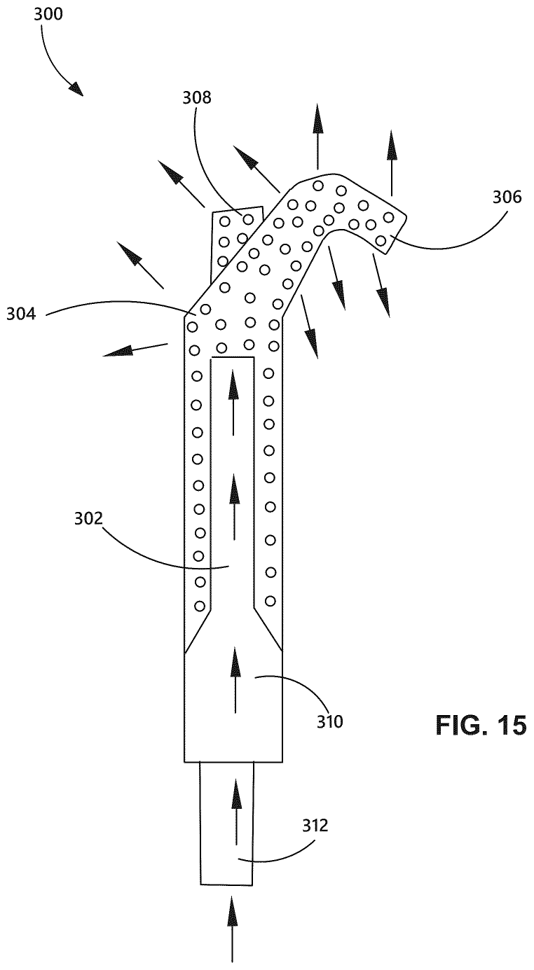

FIG. 15 depicts a hollow perforated rigid glove insert 300 which directs air flow through to the interior of a glove to dry the glove. This hollow perforated rigid glove insert 300 could be manufactured from any rigid material, such as plastic, and in differing sizes to accommodate different gloves. The hollow perforated rigid glove insert 300 includes a hollow lumen 302, a bend 304 leading up to a finger portion 306, all of which include a plurality of holes therein. Additionally, the lumen 302 leads to a thumb portion 308. Air is forced into the lumen 302 through a base portion 310 in communication with an air supply line 312. The air forced into the lumen 302 then escapes out through the plurality of holes in the hand portion 306 and the thumb portion 308 to dry the glove (see direction arrows).

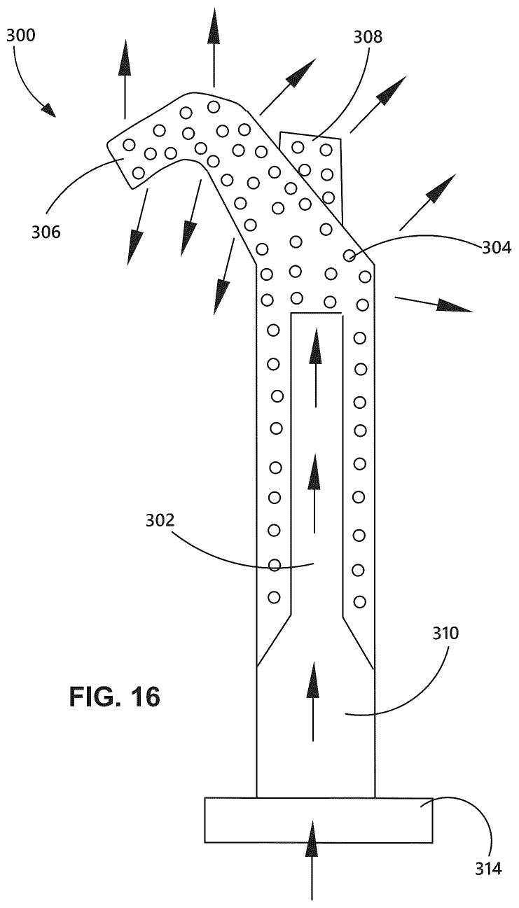

FIG. 16 depicts a hollow perforated rigid glove insert 300 which directs air flow through to the interior of a glove to dry the glove. This hollow perforated rigid glove insert 300 could be manufactured from any rigid material, such as plastic, and in differing sizes to accommodate different gloves. The hollow perforated rigid glove insert 300 includes a hollow lumen 302, a bend 304 leading up to a finger portion 306, all of which include a plurality of holes therein. Additionally, the lumen 302 leads to a thumb portion 308. Air is forced into the lumen 302 through a base portion 314 having a dual fan configuration similar to the alternate embodiment of an electrically powered hollow glove dryer 180 shown in FIG. 8 and FIG. 9. The air forced into the lumen 302 by the dual fan system 180 then escapes out through the plurality of holes in the hand portion 306 and the thumb portion 308 to dry the glove (see direction arrows).

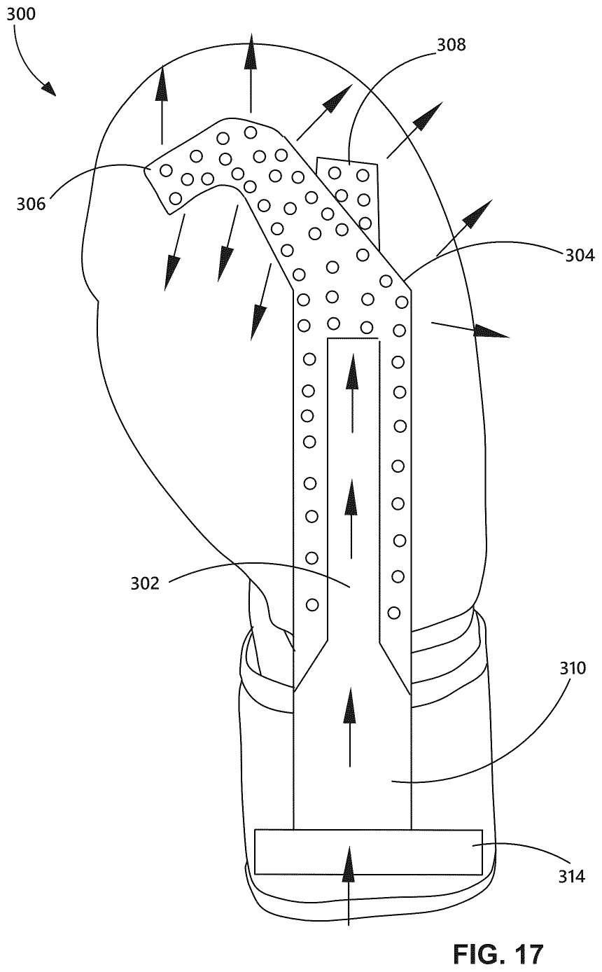

FIG. 17 depicts a hollow perforated rigid glove insert 300 which directs air flow through to the interior of a glove to dry the glove, shown in position for drying said glove, inserted into a boxing glove. Again, this hollow perforated rigid glove insert 300 could be manufactured from any rigid material, such as plastic, and in differing sizes to accommodate different gloves. The hollow perforated rigid glove insert 300 includes a hollow lumen 302, a bend 304 leading up to a finger portion 306, all of which include a plurality of holes therein. Additionally, the lumen 302 leads to a thumb portion 308. Air is forced into the lumen 302 through a base portion 314 having a dual fan configuration similar to the alternate embodiment of an electrically powered hollow glove dryer similar to that of 180 shown in FIG. 8 and FIG. 9. The air forced into the lumen 302 by the dual fan system 180 then escapes out through the plurality of holes in the hand portion 306 and the thumb portion 308 to dry the glove (see direction arrows).

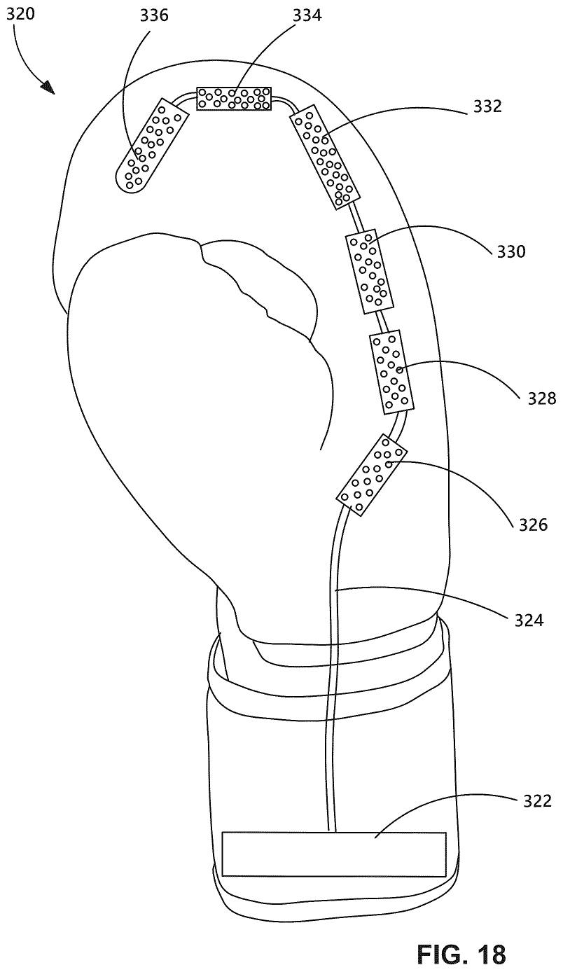

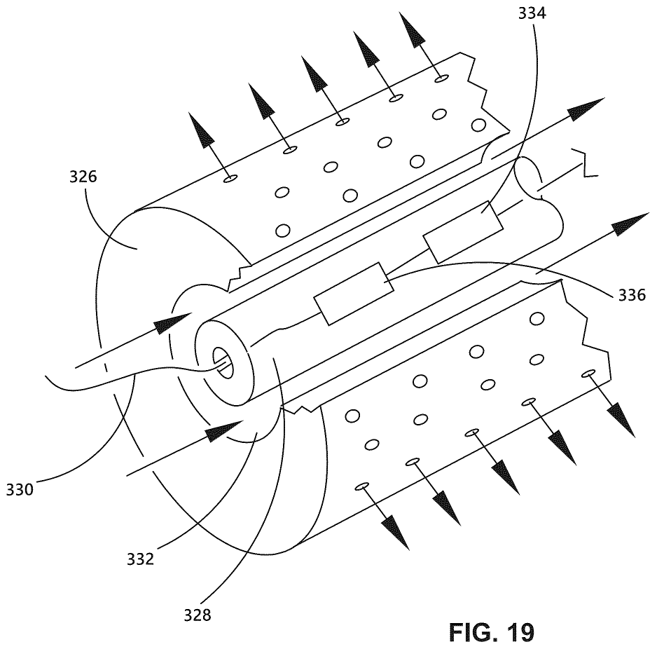

FIG. 18 depicts a flexible tube glove dryer device 320 having multiple heating elements attached thereto. This flexible tube glove dryer device 320 includes an air and electrical power supply tube 324 having a plurality of hollow heating elements 326, 328, 330, 332, 334 and 336 attached thereto. The air and electrical supply tube 324 is secured to a power and fan housing 322 similar to that of 180 shown in FIG. 8 and FIG. 9. When powered up, this air and electrical supply tube 324 sends both forced air and electrical current to the plurality of hollow heating elements 326, 328, 330, 332, 334 and 336. The detailed structure of the hollow heating elements is described below in FIG. 19.

FIG. 19 depicts a cutaway close up detailed view of one of the heating elements such as heating element 326, for example, shown in FIG. 18. The heating element 326 has a hollow core 332, in which is centrally located an insulated electrical wire 328 having a power wire 330 running to multiple heating elements 334 and 336. When air is supplied, the air is forced into the hollow core 332 (see direction arrows), heated by the heating elements 334 and 336 (when electrical power is applied to the wire 330), and sent out of the plurality of holes (see direction arrows) in the tubular hollow heating element 326.

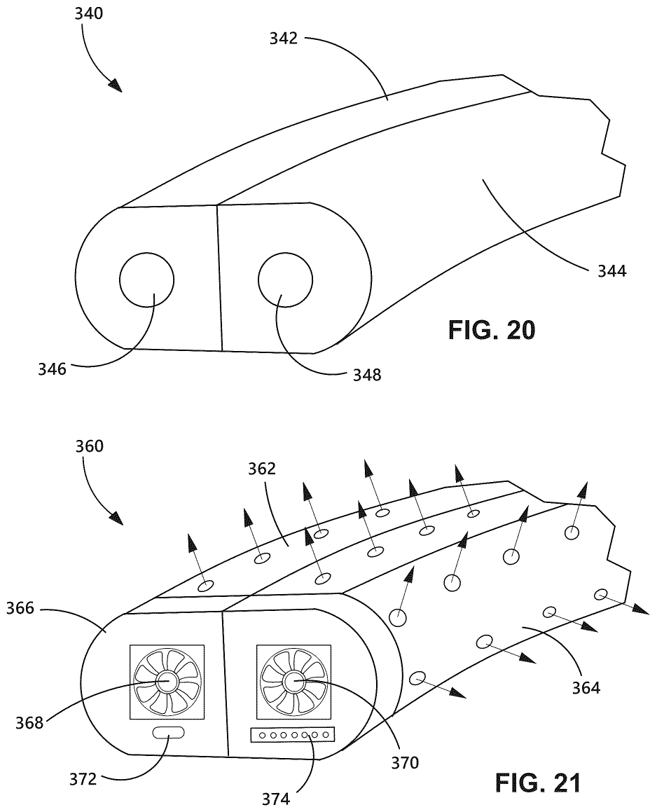

FIG. 20 depicts a front perspective view of a solid glove dryer insert 340 including two half members 342 and 344 having holes 346 and 348. These holes 346 and 348 are centrally located in each of the two half members 342 and 344 for accepting air flow from air flow fans or air flow pipes (see FIG. 21 through FIG. 27 below for greater detail).

FIG. 21 depicts a front perspective view of an alternate embodiment of a hollow glove dryer insert 360 having a plurality of holes within the two half sections 362 and 364. This hollow glove dryer insert 360 having a plurality of holes has been equipped with a removable dual fan and power housing 366 capable of circulating air, into the hollow glove dryer insert 360 when so equipped. The dual fan and power housing 366 includes a dual fan electrically powered air flow system having fans 368 and 370 as well as USB-C power cord port 372 and LED timer 374. When the fans 368 and 370 are powered on, air circulates into the hollow glove dryer insert 360 and out of the plurality of holes (see direction arrows).

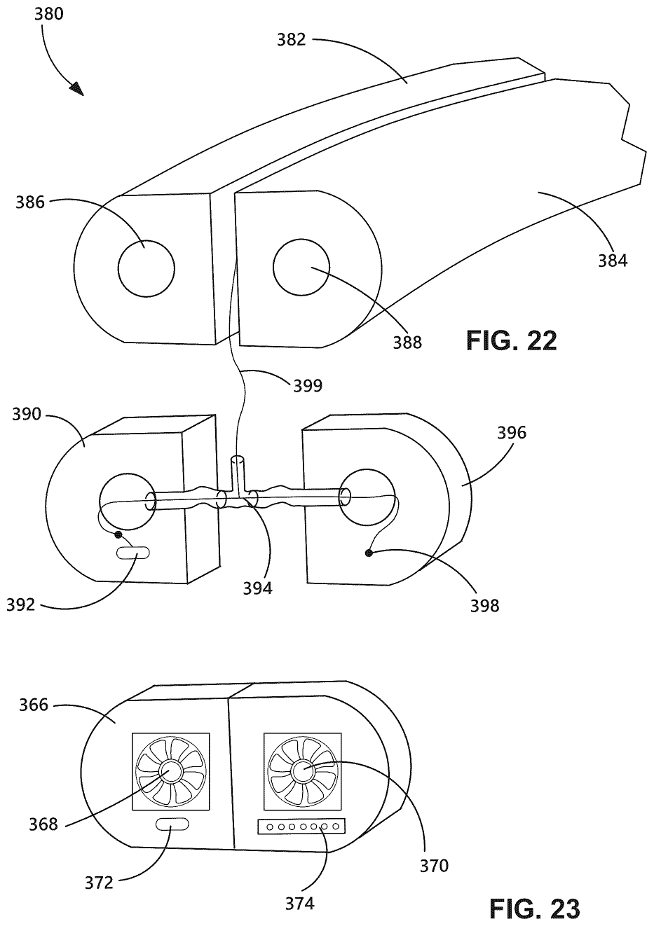

FIG. 22 depicts a breakaway view of the solid glove dryer insert 380 consisting of two half sections 382 and 384 and having holes 386 and 388 for accepting air flow from air flow fans or air flow pipes (see FIG. 23 through FIG. 27 below for greater detail). This solid glove dryer insert 380 is equipped with a dual fan electrically powered air flow system, as shown below in FIG. 23. This breakaway view illustrates the fans removed to reveal how the wiring of both fans (not shown) on both halves 390 and 396 is accomplished. Inside the electrical housing halves 390 and 396 there is a wire 394 running from the USB port 392 through half 390 in a hollow portion and into half 396 ending at wire connection point 398. There are fan wire connection points in both half 390 and half 396. In this way both fans can be powered through only one USB port 392 plug in. In addition, if desired, the electrical wire 394 can branch off into wire 399 which can run further into the solid glove dryer insert 380 for powering other electrical appliances for drying the glove.

FIG. 23 depicts a two sided dual fan electrically powered air flow system 366 mountable on the solid or hollow glove dryer insert having holes for accepting air flow fans as shown in FIG. 21 or for accepting air flow pipes as shown in FIG. 20 and FIG. 22. The two sided dual fan electrically powered air flow system 366 may include fans 368 and 370 as well as USB port 372 and timer display 374.

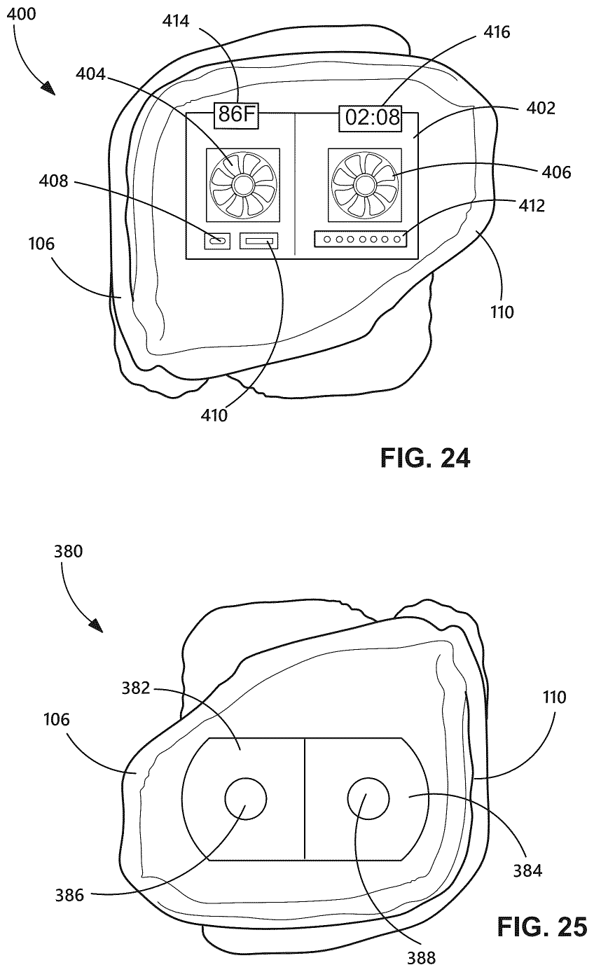

FIG. 24 depicts a hollow glove dryer insert 400 having a plurality of holes therein (not shown) capable of circulating air into the glove to be dried, here equipped with a dual fan electrically powered air flow system 402 inserted into a boxing glove cuff section 106. The dual fan electrically powered air flow system 402 includes fans 404 and 406, USB-C power port 408, USB-A power port 410 and timer display 412. Additionally, this well-appointed deluxe model dual fan electrically powered air flow system 402 includes a digital temperature gauge 414 and a digital timer display 416.

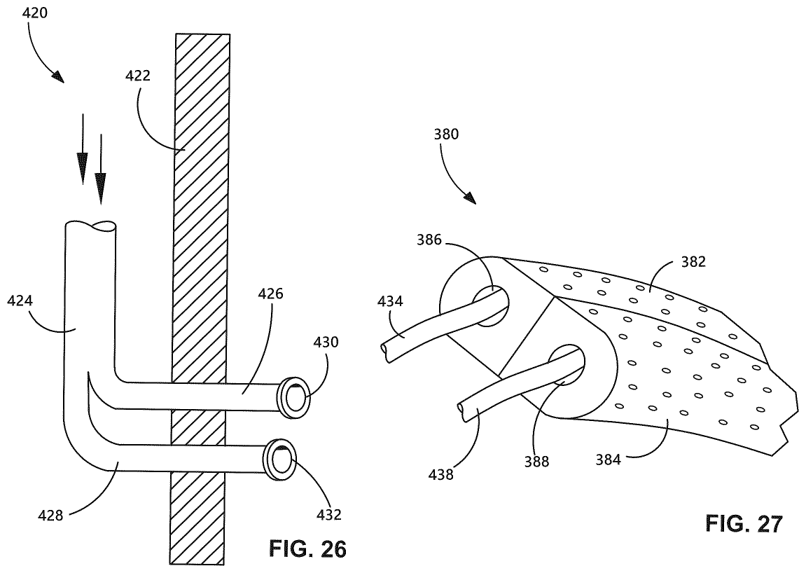

FIG. 25 depicts the solid glove dryer insert 380 as shown in FIG. 22 inserted into a boxing glove cuff portion 106. This solid glove dryer insert 380 comprises two half sections 382 and 384 having centrally located holes 386 and 388 in each of said halves 382 and 384, respectively. These holes are used to accept air flow pipes on a wall rack glove drying system (see FIG. 26) or to accept air flow supply pipes from some other source (see FIG. 27).

FIG. 26 depicts a wall rack system 420 having air flow pipes capable of mounting a glove thereon for drying. The rack system is constructed into a wall 422 and includes an air supply pipe 424 leading to one or more air feed tubes 426 and 428. The air feed tubes 426 and 428 each have a sealing rim 430 and 432, respectively, to secure the air feed tubes 426 and 428 to each of the hollow glove drying inserts, such as 360 (see FIG. 20) and 380 (see FIG. 22).

FIG. 27 depicts a front perspective view of a hollow glove dryer insert 380 having two half sections 382 and 384 wherein each half section 382 and 384 have a plurality of holes therein. The plurality of holes are capable of circulating air into the interior of a glove to be dried. Air flows into the hollow glove dryer insert 380 through the two air flow holes 386 and 388, and as shown here in FIG. 27, the air supply can be from air supply tubes 434 and 438 inserted therein as shown. The air can also be coming from the air feed tubes 426 and 428 as shown in the wall rack system 420 (see FIG. 26).

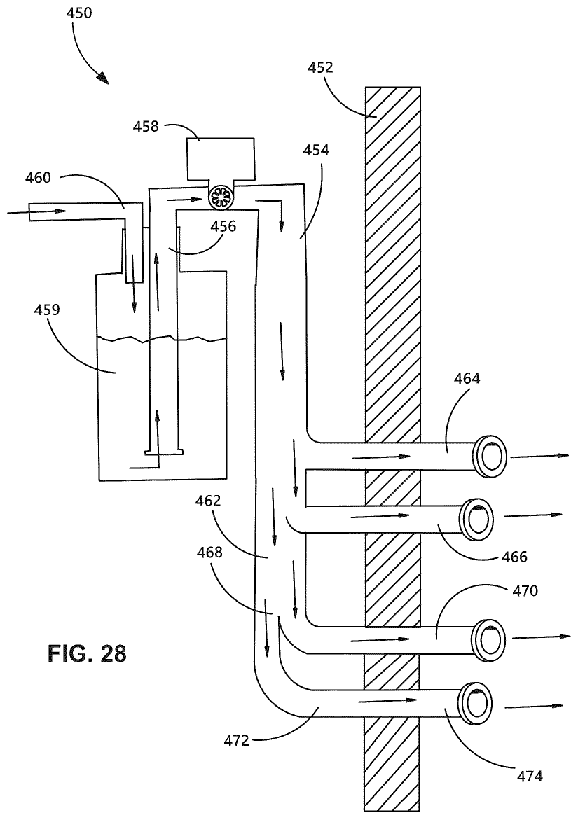

FIG. 28 depicts a multiple glove drying and sanitizing and deodorizing system 450 embodied in a wall rack 452 for mounting any number of gloves thereon. This multiple glove drying and sanitizing and deodorizing system 450 has an air supply line 454 leading to several air feed tubes 464 and 466, then it extends down further in air supply line 462 where it forks at 468 and flows air into air feed tubes 470, 472 and 474. Thus, when a solid or hollow glove dryer insert, such as 380 (see FIG. 27) is mounted on the air flow tubes, the air is directed into the glove interior space to dry the glove while it is mounted on the present wall system 450. The multiple glove drying and sanitizing and deodorizing system 450 is scalable to accommodate any number of gloves on the wall rack 452 for use in gyms, fitness centers and boxing clubs. Additionally, this multiple glove drying and sanitizing and deodorizing system 450 may have a mechanism for misting sanitizer or deodorizer into the glove prior to drying. This misting mechanism consists of a mist generator 458 in fluid communication with a reservoir 459. Air pressure coming in from air supply line 460 enters the reservoir 459 and sends fluid up tube 456 to the mist generator 458. From there mist is sent through the system via the air supply line 454 leading to several air feed tubes 464 and 466, then it extends down further in air supply line 462 where it forks at 468 and flows air into air feed tubes 470, 472 and 474 then on to the mounted gloves to be sanitized and or deodorized. The reservoir can be filled with a sanitizing solution for the purpose of sanitizing the gloves to be subsequently dried for use. Moreover, the reservoir can be filled with a deodorizing solution for the purpose of deodorizing the gloves to be subsequently dried for use. In some cases, a combination of sanitizer and deodorizer may be used to perform both the sanitizing and deodorizing functions simultaneously.

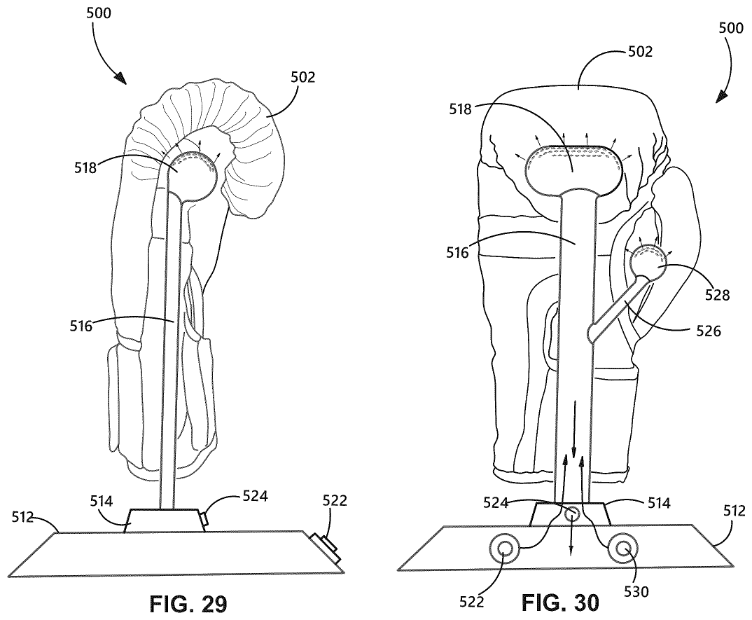

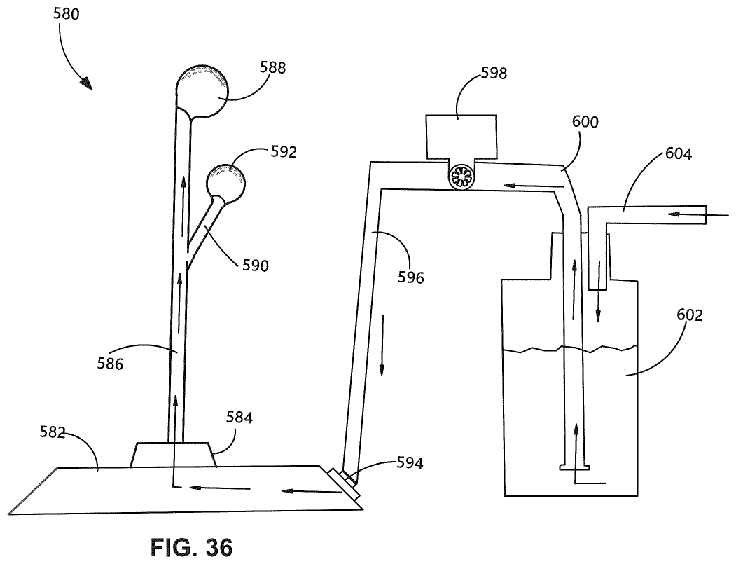

FIG. 29 depicts a hand side view of a single glove pedestal dryer device 500, having a boxing glove 502 thereon, capable of pulsating air in and out of a hollow center stand mount. The single glove pedestal dryer device 500 includes a hollow base 512, a hollow pedestal mount member 514 a central hollow shaft 516 leading up to a hollow glove hand drying bulb 518 and a hollow thumb drying bulb (not seen). The base 512 and the hollow pedestal mount member 514 have air valves, namely, intake air valve 522 and output air valve 524. These two air valves 522 and 524 allow for the pulsating of air into and out of the single glove pedestal dryer device 500. These two air valves 522 and 524 also allow for various mists to enter the single glove pedestal dryer device 500 (see FIG. 36 below).

FIG. 30 depicts a front view of a single glove pedestal dryer device 500, having a boxing glove 502 thereon, capable of pulsating air in and out of the hollow base 512, through the hollow pedestal mount member 514 and through the central hollow shaft 516 leading up to a hollow glove hand drying bulb 518 and a hollow thumb shaft 526 having a hollow thumb drying bulb 528. Here, the forced air is shown coming being forced through air valves 522 and 530. This forced air then passes through the hollow base 512 and the hollow pedestal mount member 514, up through the central shaft 516 and out the hollow glove hand drying bulb 518 as well as through the thumb shaft 526 and the thumb drying bulb 528 (see direction arrows). Additionally, the forced air may exit through the air output valve 524 (see direction arrow). Moreover, in this configuration, air can be pulsed into and out of the single glove pedestal dryer device 500 to make drying the glove more efficient and significantly quicker.

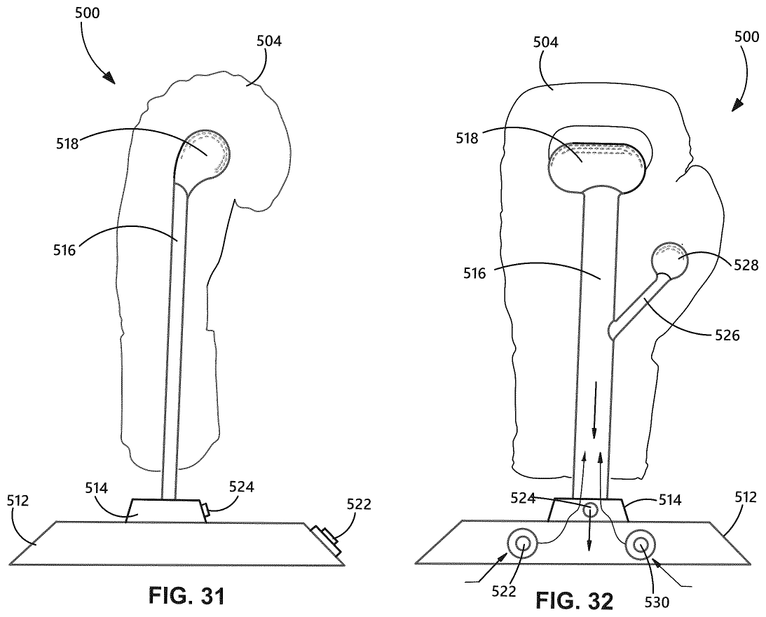

FIG. 31 depicts a hand side view of a single glove pedestal dryer device 500, having a mitten 504 thereon, capable of pulsating air in and out of a hollow center stand mount. The single glove pedestal dryer device 500 includes a hollow base 512, a hollow pedestal mount member 514 a central hollow shaft 516 leading up to a hollow glove hand drying bulb 518 and a hollow thumb drying bulb (not seen). The base 512 and the hollow pedestal mount member 514 have air valves, namely, intake air valve 522 and output air valve 524. These two air valves 522 and 524 allow for the pulsating of air into and out of the single glove pedestal dryer device 500. These two air valves 522 and 524 also allow for various mists to enter the single glove pedestal dryer device 500 (see FIG. 36 below).

FIG. 32 depicts a front view of a single glove pedestal dryer device 500, having a mitten 504 thereon, capable of pulsating air in and out of the hollow center stand mount, shown having air coming in and out simultaneously. In this view of FIG. 32, is seen the hollow base 512, through the hollow pedestal mount member 514 and through the central hollow shaft 516 leading up to a hollow glove hand drying bulb 518 and a hollow thumb shaft 526 having a hollow thumb drying bulb 528. Here, the forced air is shown coming being forced through air valves 522 and 530. This forced air then passes through the hollow base 512 and the hollow pedestal mount member 514, up through the central shaft 516 and out the hollow glove hand drying bulb 518 as well as through the thumb shaft 526 and the thumb drying bulb 528 (see direction arrows). Additionally, the forced air may exit through the air output valve 524 (see direction arrow). Moreover, in this configuration, air can be pulsed into and out of the single glove pedestal dryer device 500 to make drying the glove more efficient and significantly quicker.

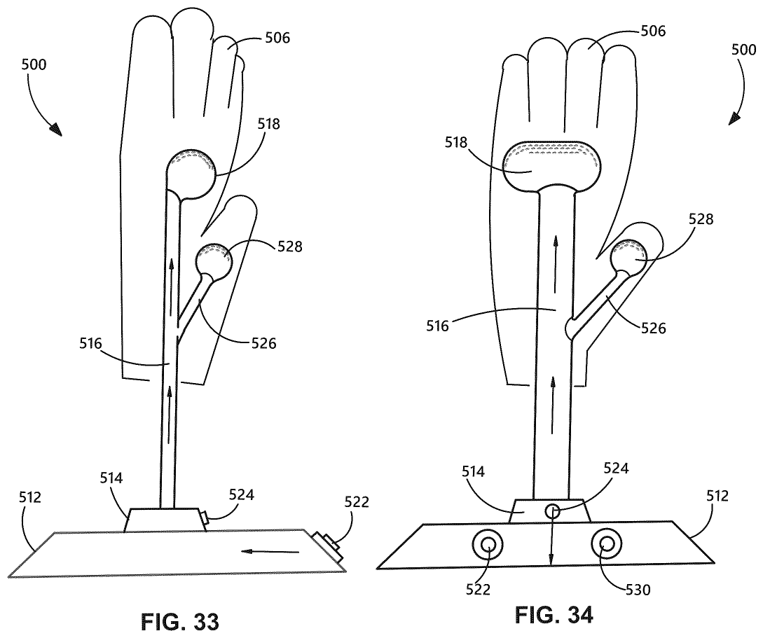

FIG. 33 depicts a side view of a single glove pedestal dryer device 500, having a fingered glove 506 thereon, capable of pulsating air in and out of a hollow center stand mount. Here in FIG. 33, the device is shown only having air forced into the hollow base 512 through the air valve 522 and up the central shaft 516 to be forced out both the hand drying bulb 518 and the thumb drying bulb 528. The single glove pedestal dryer device 500 includes a hollow base 512, a hollow pedestal mount member 514 a central hollow shaft 516 leading up to a hollow glove hand drying bulb 518 and a hollow thumb drying bulb (not seen). The base 512 and the hollow pedestal mount member 514 have air valves, namely, intake air valve 522 and output air valve 524. These two air valves 522 and 524 allow for the pulsating of air into and out of the single glove pedestal dryer device 500. These two air valves 522 and 524 also allow for various mists to enter the single glove pedestal dryer device 500 (see FIG. 36 below). In this way, the glove is dried by forced air coming in to the single glove pedestal dryer device 500 only.

FIG. 34 depicts a side view of a single glove pedestal dryer device 500, having a fingered glove 506 thereon, capable of pulsating air in and out of the hollow center stand mount 512, here shown having air both going in and coming out. This is accomplished in two different ways. First, the air is forced into air valves 522 and 530. This forced air then passes through the hollow base 512 and the hollow pedestal mount member 514, up through the central shaft 516 and out the hollow glove hand drying bulb 518 as well as through the thumb shaft 526 and the thumb drying bulb 528 (see direction arrows). Second, the forced air may exit through the air output valve 524 (see direction arrow) by force of pulsation, or passively by the pressure exerted from the air being forced into air valves 522 and 530 and then out of output air valve 524. Moreover, in this configuration, air can be pulsed into and out of the single glove pedestal dryer device 500 to make drying the glove more efficient and significantly quicker.

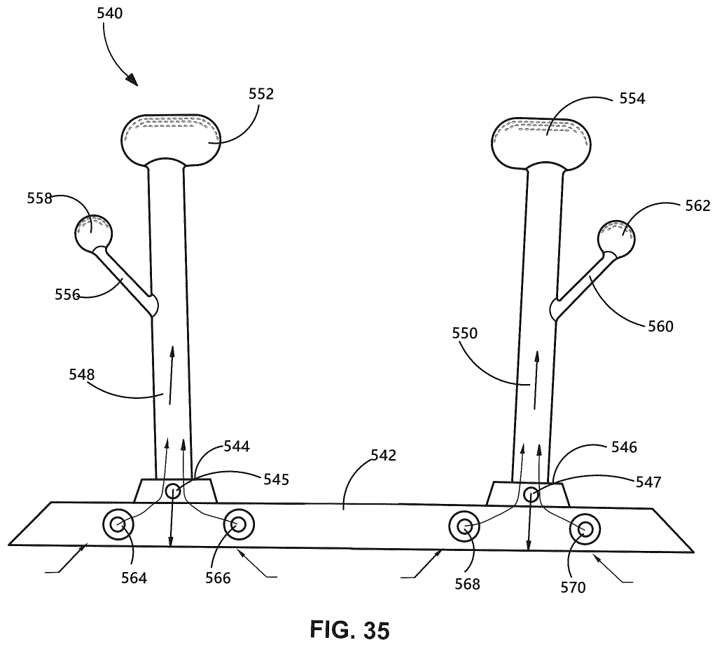

FIG. 35 depicts a front view of a double glove pedestal dryer device 540 capable of pulsating air in and out of the hollow center stand mounts to accomplish the drying, sanitizing and deodorizing of two gloves simultaneously. Here, air is forced into air valves 564 and 566, through the pedestal mount 544, up the central shaft 548 through the thumb shaft 556 and out of the hand drying bulb 552 while also exiting the thumb drying bulb 558. Additionally, since this is a dual glove drying system 540, air is also forced through into air valves 568 and 570, through the pedestal mount 547, up the central shaft 550 through the thumb shaft 560 and out of the hand drying bulb 554 while also exiting the thumb drying bulb 562 simultaneously to allow for the drying of two gloves at the same time. Furthermore, forced air coming in can freely exit through the air output valves 545 and 547 located in the hollow pedestal mount 544 and 546, respectively (see direction arrows), or be pulsed out by applying negative air pressure through air output valves 545 and 547 located in the hollow pedestal mount 544 and 546.

FIG. 36 depicts a single or double configured glove pedestal dryer device system 580 capable of pulsating a sanitizing and deodorizing mist coming from a liquid reservoir and a misting mechanism. This single or double configured glove pedestal dryer device system 580 includes a hollow base 582, a hollow pedestal mount 584, a centrally located hand shaft 586 and thumb shaft 590 and a hand drying bulb 588 as well as a thumb drying bulb 592. In this particular configuration, the system 580 is structured to accept a mist through air input valve 594 which is coming in from mist feed tube 596, wherein the mist is generated by a mist generator 598, being fed a liquid from liquid feed tube 600 coming from reservoir 602. Reservoir 602 includes a forced air input line 604. Reservoir 602 may be filled with a sanitizing solution or a deodorizing solution, or both. By using this system 580 before glove drying, the gloves to be dried can be both sanitized and deodorized prior to drying.

Glove Dryer, Sanitizer, Deodorizer and Shape Maintainer primary features will include as prominent design and operational features: hollow or solid glove drying members having the ability to dry gloves efficiently; hollow or solid glove drying members having the ability to dry gloves efficiently including internal glove hand and thumb width adjustment mechanisms structured to maintain the shape of the glove during the drying process; optionally including a system to introduce forced air into the hollow glove drying members; optionally including glove drying inserts having electrically powered fans to introduce forced air into the hollow glove drying members; having glove drying inserts which enable wall rack mounting; having the wall rack systems capable of providing electrical power and forced air through air supply lines; wall rack systems capable of providing a mist of sanitizing compounds, and deodorizing compounds or both; glove drying members having heating elements therein for expedited glove drying; single or double pedestal glove drying devices capable of accepting forced air, pulsed air and a mist of sanitizing compounds, and deodorizing compounds or both.

The Glove Dryer, Sanitizer, Deodorizer and Shape Maintainer 120, 140, 180, 220, 250, 280, 300, 320, 340, 360, 380, 400, 420, 450, 500, 540 and 580, which are all obvious variants, shown in the drawings and described in detail herein disclose arrangements of elements of particular construction and configuration for illustrating preferred embodiments of structure and method of operation of the present application. It is to be understood, however, that elements of differing construction and configuration and other arrangements thereof, other than those illustrated and described may be employed for providing the Glove Dryer, Sanitizer, Deodorizer and Shape Maintainer 120, 140, 180, 220, 250, 280, 300, 320, 340, 360, 380, 400, 420, 450, 500, 540 and 580, which are all obvious variants, in accordance with the spirit of this disclosure, and such changes, alternations and modifications as would occur to those skilled in the art are considered to be within the scope of this design concept as broadly defined in the appended claims.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. For example, one portion of one of the embodiments described herein can be substituted for another portion in another embodiment described herein. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process, so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Further, the purpose of the foregoing abstract is to enable the U.S. Patent and Trademark Office, foreign patent offices worldwide and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limited as to the scope of the invention in any way.

We claim:

1. A glove dryer sanitizer, deodorizer and shape maintainer, comprising:
a) one or more glove drying insert members structured to be inserted into a glove; and
b) a moving wedge width adjustment portion configured to enable width adjustment of said one or more glove drying insert members;
wherein said glove insert members are inserted into a glove for the purpose of enabling a glove drying process to dry the interior of the glove, and whereby said moving wedge width adjustment portion is adjusted to maintain the glove shape during said drying process.

2. The glove dryer, sanitizer, deodorizer and shape maintainer according to claim 1, wherein said one or more glove drying insert members are solid.

3. The glove dryer, sanitizer, deodorizer and shape maintainer according to claim 1, wherein said one or more glove drying insert members are hollow.

4. The glove dryer, sanitizer, deodorizer and shape maintainer according to claim 3, wherein said one or more hollow glove drying insert members are perforated and include a plurality of holes therein.

5. The glove dryer, sanitizer, deodorizer and shape maintainer according to claim 3, wherein said hollow glove drying members include air accepting holes.

6. The glove dryer, sanitizer, deodorizer and shape maintainer according to claim 4, wherein said glove drying members with air accepting holes include electrically powered fans for generating forced air into said air accepting holes.

7. The glove dryer, sanitizer, deodorizer and shape maintainer according to claim 4, wherein said glove drying members with air accepting holes are structured to accept air supply lines for providing forced air into said air accepting holes.

8. The glove dryer, sanitizer, deodorizer and shape maintainer according to claim 1, further including a wall rack drying system wherein said one or more glove drying insert members include rack mounting members structured to be mounted on said wall rack drying system.

9. The glove dryer, sanitizer, deodorizer and shape maintainer according to claim 1, further including a pedestal drying system wherein said one or more glove drying insert members are incorporated into said pedestal drying system.

10. The glove dryer, sanitizer, deodorizer and shape maintainer according to claim 1, wherein said one or more glove drying insert members include heating elements.

11. A method for making a glove dryer, sanitizer, deodorizer and shape maintainer, comprising the steps of:
a) providing one or more glove drying insert members structured to be inserted into a glove; and
b) providing a moving wedge width adjustment portion configured to enable width adjustment of said one or more glove drying insert members;
wherein said glove insert members are inserted into a glove for the purpose of enabling a glove drying process to dry the interior of the glove, and whereby said moving wedge width adjustment portion is adjusted to maintain the glove shape during said drying process.

12. The method of making a glove dryer, sanitizer, deodorizer and shape maintainer according to claim 11, wherein said one or more glove drying insert members are solid.

13. The method of making a glove dryer, sanitizer, deodorizer and shape maintainer according to claim 11, wherein said one or more glove drying insert members are hollow.

14. The method of making a glove dryer, sanitizer, deodorizer and shape maintainer according to claim 13, wherein said one or more hollow glove drying insert members are perforated and include a plurality of holes therein.

15. The method of making a glove dryer, sanitizer, deodorizer and shape maintainer according to claim 13, wherein said hollow glove drying members include air accepting holes.

16. The method of making a glove dryer, sanitizer, deodorizer and shape maintainer according to claim 14, wherein said glove drying members with air accepting holes include electrically powered fans for generating forced air into said air accepting holes.

17. The method of making a glove dryer, sanitizer, deodorizer and shape maintainer according to claim 14, wherein said glove drying members with air accepting holes are structured to accept air supply lines for providing forced air into said air accepting holes.

18. The method of making a glove dryer, sanitizer, deodorizer and shape maintainer according to claim 11, further including a wall rack drying system wherein said one or more glove drying insert members include rack mounting members structured to be mounted on said wall rack drying system.

19. The method of making a glove dryer, sanitizer, deodorizer and shape maintainer according to claim 11, further including a pedestal drying system wherein said one or more glove drying insert members are incorporated into said pedestal drying system.

20. The method of making a glove dryer, sanitizer, deodorizer and shape maintainer according to claim 11, wherein said one or more glove drying insert members include heating elements.
